(19) United States
(12) Patent Application Publication
(10) Pub. No.: US 2025/0198876 A1
(43) Pub. Date: Jun. 19, 2025

(54) LEAK DETECTION IN PIPE SYSTEMS

(71) Applicant: The ADT Security Corporation, Boca Raton, FL (US)

(72) Inventor: Jeron E. BORNSTEIN, Delray Beach, FL (US)

(21) Appl. No.: 18/543,814

(22) Filed: Dec. 18, 2023

(51) Int. Cl. G01M 3/28

(52) U.S. Cl. CPC G01M 3/2815

(57) ABSTRACT

Methods and apparatuses are described herein. In an example embodiment, a leak detector is provided. The leak detector includes a first fitting configured to couple to an outlet of a pipe system and a fluid pressure sensor configured to generate a plurality of fluid pressure measurements corresponding to fluid pressure in the pipe system. The leak detector is configured to generate fluid pressure data based on the plurality of fluid pressure measurements, the fluid pressure data including data representing at least a steady state pressure and a dynamic state pressure; determine, based on at least the fluid pressure data, that a current fluid pressure of the pipe system satisfies at least one leak condition; detect a leak based on the at least one leak condition being satisfied; and cause an alert to be generated based on the leak being detected.

### TECHNICAL FIELD

The present technology is generally related to leak detection in a pipe system.

### BACKGROUND

The ability to detect a water leak (such as a slow leak, which may be referred to as a microleak) in a pipe system, such as the plumbing system of a home or other structure, may help prevent damage to contents and even the structure itself. Some existing approaches to leak detection require a device to be placed in-line, i.e., between the water source (such as a connection to a municipal water supply) and all portions of the pipe system where leak monitoring is desired. Other existing solutions require that individual sensors be placed in-line throughout the pipe system. Further, other existing solutions rely on water “pucks” that detect leaked water that comes into contact with the puck, i.e., water sensor.

### BRIEF DESCRIPTION OF THE DRAWINGS

A more complete understanding of the present disclosure, and the attendant advantages and features thereof, will be more readily understood by reference to the following detailed description when considered in conjunction with the accompanying drawings wherein:

FIG. 1 is a schematic diagram of an example pipe system according to some embodiments of the present disclosure;

FIG. 2 is a block diagram of an example leak detector of FIG. 1 according to some embodiments of the present disclosure;

FIG. 3 is a flowchart of an example process in a leak detector according to some embodiments of the present disclosure; and

FIG. 4 is a side view of an example leak detector of FIG. 1 that is removably coupled to a pipe according to some embodiments of the present disclosure.

### DETAILED DESCRIPTION

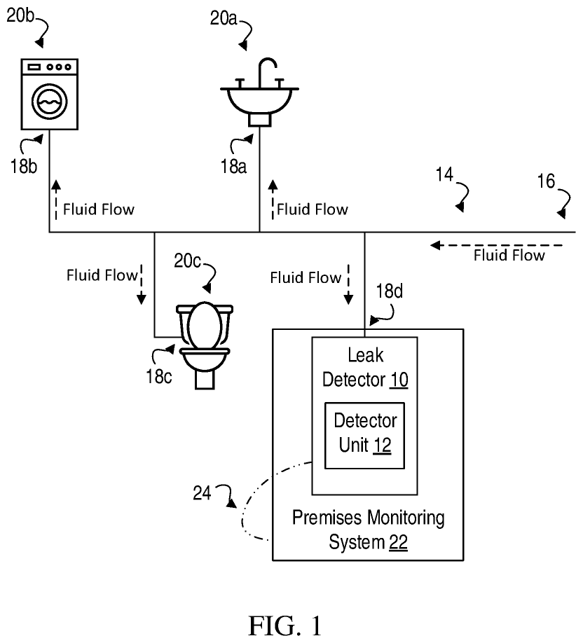

With reference to FIG. 1, shown is a schematic diagram of an example pipe system 14. The pipe system 14, as described herein, may be, e.g., a water pipe system, such as the plumbing system for a dwelling or other structure However, it should be appreciated that the principles described herein are not limited to water and may also be applied to pipe systems for carrying other fluids. Furthermore, the teachings of the present disclosure are not limited to pipe systems of a structure and may be adapted for pipe systems that are external to or unassociated with a structure, such as an irrigation system.

The pipe system 14 includes one or more inlets 16 (collectively referred to as inlet 16) that supply water to the pipe system 14. The inlet 16 may be, e.g., a connection to a municipal water supply or may connect the pipe system 14 to a well supply. The pipe system 14 also includes a plurality of outlets 18a-18d (collectively referred to as “outlet 18”) through which the water exits the pipe system 14. Examples of outlets 18 include hose spigots and other types of plumbing fittings for appliances or fixtures 20a-20c, such as but not limited to faucets, sinks, toilets, showers, clothes washers, and refrigerators (collectively “appliance or fixture 20”). Though FIG. 1 depicts four examples of outlets 18 and three examples of appliances or fixtures 20, the number of outlets 18 and appliances or fixtures 20 of a pipe system 14 may vary and may be greater than or less than the number shown in FIG. 1.

A leak detector 10 is removably coupled to an outlet 18d of the pipe system 14 in the example of FIG. 1. The leak detector 10 is configured to include a detector unit 12, where detector unit 12 is configured to perform one or more leak detector 10 functions described herein, including functions related to leak detection in the pipe system 14.

According to one or more embodiments, the leak detector 10 may be part of a premises monitoring system 22. For example, the leak detector 10 may be configured to communicate, such as via a wired and/or wireless connection 24, with one or more components of the premises monitoring system 22. Premises monitoring system 22 may be configured to provide functionality relating to premises monitoring. For example, premises monitoring system 22 may be used to detect burglaries, smoke, fires, carbon monoxide leaks, water leaks, etc. and report detected events to a remote monitoring system (not shown in FIG. 1). Additionally, the premises monitoring functionality performed by premises monitoring system 22 may include home automation functionality. Examples of home automation functionality include thermostat control, door lock control, lighting control, appliance control, entertainment system control, etc.

Premises monitoring system 22 may comprise a control device (not shown in FIG. 1) that may be configured to control various aspects of premises monitoring system 22. For example, the control device may be configured to control premises devices (now shown in FIG. 1), such as locks, doors, windows, actuators, valves, motors, and any other controllable devices associated with premises monitoring system 22. Control device may include a user interface, such as buttons, a touch screen, a display, a microphone, a speaker, and/or other types of user interface components, to facilitate a user interacting with and controlling premises monitoring system 22.

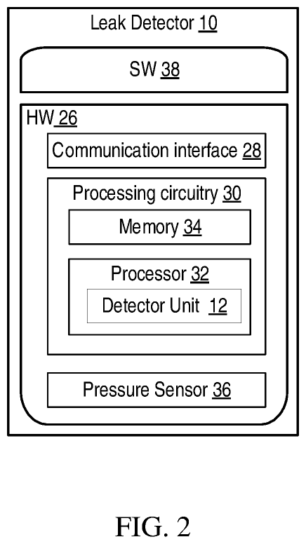

FIG. 2 is a diagram of an example leak detector 10 according to various embodiments of the present disclosure. As shown, leak detector 10 comprises hardware 26. Hardware 26 may include a communication interface 28 configured to support wired and/or wireless communication between leak detector 10 and, e.g., one or more components of the premises monitoring system 22, such as through WI-FI, BLUETOOTH, ZIGBEE, USB, Serial, Inter-Integrated Circuit (I2C), Ethernet, etc. protocols.

The hardware 26 may further include processing circuitry 30. The processing circuitry 30 may include one or more processors 32 and one or more memories 34. Each processor 32 may include and/or be associated with one or more central processing units, data buses, buffers, and interfaces to facilitate operation. In addition to or instead of a processor 32 and memory 34, the processing circuitry 30 may comprise other types of integrated circuitry that perform various functionality. Integrated circuitry may include one or more processors 32, processor cores, field programmable gate arrays (FPGAs), application specific integrated circuits (ASICs), graphics processing units (GPUs), Systems on Chips (SoCs), or other components configured to execute instructions. The processor 32 may be configured to access (e.g., write to and/or read from) the memory 34, which may comprise any kind of volatile and/or nonvolatile memory, e.g., cache, buffer memory, random access memory (RAM), read-only memory (ROM), optical memory, and/or erasable programmable read-only memory (EPROM). Further, the memory 34 may be embodied in the form of one or more storage devices. The processing circuitry 30 may be configured to perform various functionality described herein. For example, computer instructions may be stored in memory 34 and/or another computer-readable medium that, when executed by the processor 32, causes the processor 32 to perform various functionality described herein.

Hardware 26 of leak detector 10 may further comprise a pressure sensor 36 configured for measuring fluid pressure. Pressure sensor 36 may comprise one or more components such as one or more of absolute, gauge, or differential pressure sensors which may be, e.g., resistive, capacitive, piezoelectric, optical, and/or micro electro-mechanical (MEMS). In one or more embodiments, the pressure sensor 36 may operate based on static fluid flow as opposed to a dynamic or constant fluid flow. That is, in one or more embodiments, after leak detector 10 has been filled or received fluid from pipe system 14, fluid flow through leak detector 10 may not be used by pressure sensor 36 to capture fluid pressure data. For example, after the leak detector 10 receives fluid from a first outlet 18 of pipe system 14 and the remaining outlets 18 of pipe system 14 are closed, pressure sensor 36 may generate pressure data that indicates whether a leak or microleak is occurring in pipe system 14.

Leak detector 10 may further comprise software 38 (which may include one or more software applications) stored internally in, for example, memory 34, or stored in external memory (e.g., database, storage array, network storage devices, etc.) accessible by the leak detector 10 via an external connection. Software 38 may include any software or program that configures processing circuitry 30 to perform the steps or processes of the present disclosure.

The processing circuitry 30 may be configured to control any of the methods and/or processes described herein and/or to cause such methods, and/or processes to be performed, e.g., by leak detector 10. One or more processors 32 may cause leak detector 10 functions to be performed as described herein. The memory 34 is configured to store data, programmatic software code and/or other information described herein. In some embodiments, the software 38 may include instructions that, when executed by the processor 32 and/or processing circuitry 30, causes the processor 32 and/or processing circuitry 30 to perform the processes described herein with respect to leak detector 10. Accordingly, by having computer instructions stored in memory 34 accessible to the processor 32, the processor 32 may be configured to perform the actions described herein.

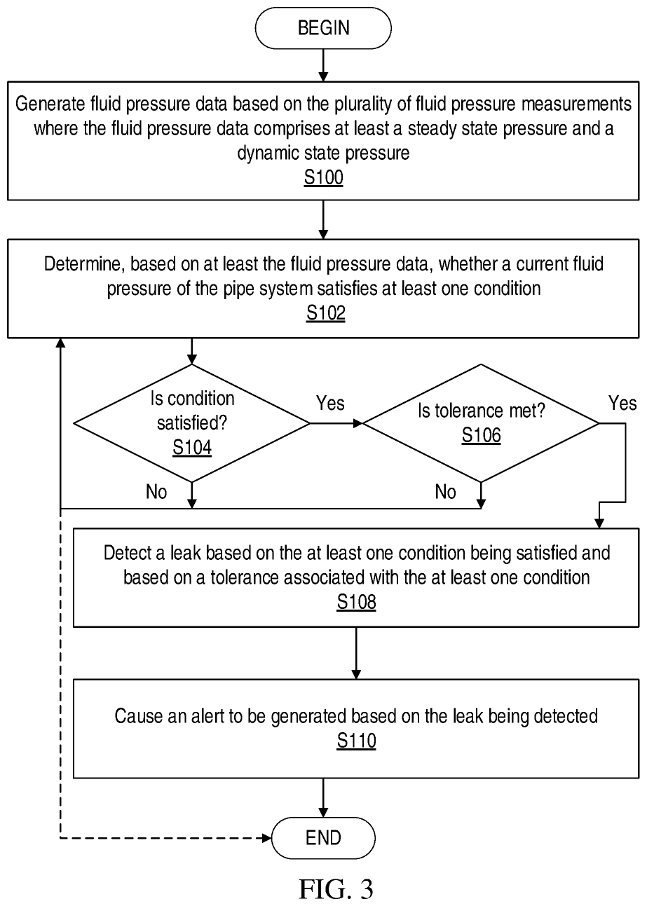

FIG. 3 is a flowchart of an example process in a leak detector 10 according to some embodiments of the present disclosure. One or more blocks described herein may be performed by one or more elements of leak detector 10 such as by one or more of processing circuitry 30 (including the detector unit 12), processor 32, and/or communication interface 28. The following discussion assumes that the leak detector 10 has already been coupled to an outlet 18 of pipe system 14, that the outlet 18 has been opened to allow fluid to flow into the leak detector 10, and that all other outlets 18 of the pipe system have been closed.

Beginning at S100, leak detector 10 generates fluid pressure data based on the plurality of fluid pressure measurements, where the fluid pressure data comprises at least a steady state pressure and a dynamic state pressure (Block S100). For example, when leak detector 10 is removably coupled to outlet 18 of pipe system 14, the pressure sensor 36 generates the plurality of fluid pressure measurements corresponding to fluid pressure in the pipe system 14. Measurements may be obtained at various predefined intervals and/or in response to a triggering event such as, for example, one or more of the arming of premises monitoring system 22, a predefined time (e.g., at night when occupants of the premises are sleeping), a predefined day, or upon received a measurement command.

At S102, leak detector 10 determines, based on at least the fluid pressure data, whether a current fluid pressure of the pipe system 14 satisfies at least one condition (Block S102). According to one or more embodiments, the at least one condition comprises at least one of: the current pressure being lower than the steady state pressure, when the leak detector 10 is in a first operative mode and the at least one inlet 16 and the plurality of outlets 18 are closed, or the current pressure being lower than the dynamic state pressure, when the leak detector 10 is in a second operative mode and the at least one inlet 16 and at least a first outlet 18 of the plurality of outlets are open.

The steady state pressure may correspond to a “steady” fluid pressure in the pipe system 14, such as when inlet 16 and outlets 18 are all closed. Causing the leak detector 10 to be in the first operative mode in which the at least one inlet 16 and the plurality of outlets 18 are closed facilitates testing of steady state pressure, which can be used to detect “micro-leaks,” e.g., leaks with a flow rate at or near 1 mL per minute and/or associated with a pressure drop of approximately 1 psi or less. The leak detector 10 may be put in the first operative mode by, e.g., a user interacting with the leak detector 10 and/or the premises monitoring system 22 and selecting a button or user interface element that instructs the leak detector 10 to enter the first operative mode. Further, dynamic state pressure may correspond to a “dynamic” fluid pressure in the pipe system 14, such as when an inlet 16 and/or outlet 18 are open, e.g., when an appliance or fixture 20 is in use. Causing the leak detector 10 to be in the second operative mode facilitates testing of dynamic state pressure, which may facilitate leak detection when fluid is flowing through the pipe system 14, e.g., due to use of an appliance or fixture 20 consuming or outputting fluid. The leak detector 10 may be put in the second operative mode by, e.g., a user interacting with the leak detector 10 and/or the premises monitoring system 22 and selecting a button or user interface element that instructs the leak detector 10 to enter the second operative mode.

In some embodiments, when the leak detector 10 enters the first operative mode, the leak detector 10 may cause the inlet 16 and/or outlets 18 to close, e.g., by transmitting a signal to one or more valve controllers that control inlet(s) 16 and/or outlet(s) 18, and/or by transmitting a signal to the premises monitoring system 22 which may then command the inlet(s) 16 and/or outlet(s) 18 to close. The leak detector 10 may exit the first operative mode after a predetermined duration and may re-open inlet 16 and/or outlets 18 that were previously closed when the leak detector 10 entered the first operative mode.

According to various embodiments, an inlet 16 or outlet 18 may be considered closed or in a closed position even if the inlet 16 or outlet 18 itself is leaking due to, for example, a failed gasket or seal. Because the leak detector 10 couples to an outlet 18 of the pipe system 14 and is configured to detect leaks using the techniques described herein, the leak detector 10 can detect a leak occurring in an inlet 16 and/or outlet 18 itself as well as in spans of pipes in the pipe system 14.

Still referring to FIG. 3, if the at least one condition is satisfied (Block S104), leak detector 10 determines whether a tolerance is met (Block S106). If the condition is not satisfied (Block S104), the process may return to Block S102 or the process may end. According to one or more embodiments, the tolerance is defined by a state of the premises monitoring system 22, where the state is one of a home state, an away state, or an armed state. The tolerance may relate to a sensitivity and/or threshold for detecting a leak. For example, when the premises monitoring system 22 is in a state corresponding to a user being present in the premises, such as an “armed-stay” state, the tolerance may be higher than when the premises monitoring system 22 is in a state corresponding to the user being absent from the premises, such as an “armed-away” state. A high tolerance value may correspond to the leak detector 10 not detecting a fluid leak unless the difference between the current fluid pressure and the steady state pressure and/or dynamic state pressure is greater than a predefined value or threshold. For example, a condition may be satisfied (as described above) by the current pressure being lower than the steady state pressure when the leak detector 10 is in a first operative mode and the at least one inlet 16 and the plurality of outlets 18 are closed. The tolerance value relates to how much lower the current pressure may need to be before the leak is detected. In one or more embodiments, if the tolerance value is met, the leak detector 10 detects the leak as described below (Block S108). If the tolerance value is not met, the leak detector 10 may repeat the determination step at S102 using an updated current fluid pressure, or may end the process of FIG. 3.

With further reference to FIG. 3, leak detector 10 is configured to detect a leak based on at least one condition being satisfied and based on a tolerance associated with the at least one condition (Block S108). In some embodiments, the leak is detected based on the leak detector 10 monitoring fluid pressure in the pipe system 14 (e.g., dynamic state pressure and/or steady state pressure) over a predetermined amount of time. For example, the leak detector 10 may average dynamic state pressure and/or steady state pressure readings, respectively, over predetermined time periods and determine whether a leak exists based on the average dynamic state pressure and/or average steady state pressure.

Still referring to FIG. 3, leak detector 10 is configured to cause an alert to be generated based on the leak being detected (Block S110). In some embodiments, causing the alert to be generated includes transmitting a signal to a user device, such as a mobile device (e.g., a smartphone with an application for the leak detector 10 and/or premises monitoring system 22), and/or the premises monitoring system 22 to cause an audio and/or graphical message to be produced for the user. The message may indicate to the user that a leak was detected. The message may also include indicia corresponding to a severity of the leak or may communicate instructions to the user for addressing and/or mitigating the leak (e.g., to instruct the user to close one or more of the inlet 16 and outlets 18). In some embodiments, the leak detector 10 responsive to detecting the leak may cause one or more of the inlet 16 and outlets 18 to close.

In some embodiments, leak detector 10 is configured to enter the first operative mode in which it generates pressure data when the at least one inlet 16 and the plurality of outlets 18 are closed based on a schedule. For example, because the first operative mode may correspond to restricted usage of some appliances or fixtures 20 due to the inlet 16 and outlets 18 being closed, it may be desirable that the first operative mode be entered when the structure is expected to be unoccupied, or when occupants are expected to be asleep.

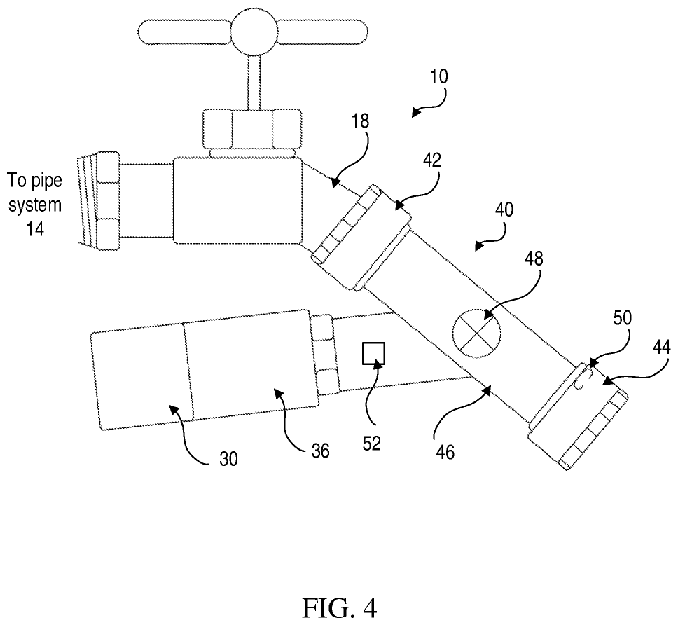

FIG. 4 shows a side view of an example leak detector 10 according to some embodiments of the present disclosure. The leak detector 10 has a body 40 that is coupled to a first fitting 42. The first fitting 42 is configured to be removably coupled to an outlet 18 of the pipe system 14. In various embodiments, the outlet 18 can be, for example, a spigot for a garden hose on the exterior of a building structure, a plumbing fitting (such as a valve with a threaded connection) for an appliance (such as a clothes washer), a faucet, etc. Accordingly, the first fitting 42 in various embodiments can be configured to couple to spigots, valves, faucets, and other types of plumbing fittings.

The body 40 has an internal passage 46 that is configured to be in fluid communication with the pipe system 14 when the first fitting 42 is connected to the outlet 18. Fluid is permitted to pass from the outlet 18 to the pressure sensor 36 by way of the internal passage 46. In some embodiments, the leak detector 10 may include a bleed valve 52 operable to release gas (e.g., air) from the internal passage 46. For example, gas may become trapped in the internal passage 46 and interfere with the pressure sensor 36's ability to accurately measure fluid pressure such that releasing the gas via the bleed valve may improve accuracy of the leak detector 10.

Installation of a leak detector 10 may include removably coupling the leak detector 10 to an outlet 18, such as a spigot of a home or other structure, that is closed. The outlet 18 is then opened to permit the internal passage 46 to fill with fluid. The bleed valve 52 may be opened to allow any air or gas to exit the leak detector 10. Once all air has been released from leak detector 10, the bleed valve 52 is closed. The leak detector 10 may then be operative to detect a leak that may be present in the pipe system 14, as described herein.

In some embodiments, the leak detector 10 may be configured for operation in a range of 0 pounds per square inch gauge (PSI-G) to 200 PSI-G, though some embodiments may also operate in excess of 200 PSI-G. The pressure sensor 36 may be incorporated in an end-cap of a ¾ inch cylinder, e.g., as part of the body 40. The other end of the cylinder may use, e.g., a ¾ inch garden hose thread (GHT) female fitting, e.g., for the first fitting 42. This allows the leak detector 10 to be screwed into the outlets 18 that may be common to homes and structures, e.g., a ¾ inch GHT male garden hose spigot such as may be used to attach an appliance or fixture 20, such as a washing machine or sink.

In some embodiments, the leak detector 10 is configured to allow use of the outlet 18 without impacting the ability of the leak detector 10 to detect leaks. For example, some embodiments of leak detector 10 additionally include a second fitting 44. The second fitting 44 is also in fluid communication with the internal passage 46. The second fitting 44 may be configured for connection to an appliance, fixture 20, hose (such as a garden hose), etc. In some embodiments, a valve 48 may be configured to permit or prevent fluid from flowing from the pipe system 14 and out the leak detector 10. In some embodiments, when the appliance or fixture 20 is attached to the second fitting 44, a switch 50 is configured to cause the valve 48 to open when the hose is connected to the second fitting 44 and to cause the valve 48 to close when the hose is not connected to the second fitting 44. The switch may be, e.g., a mechanical switch that is depressed when the hose is connected to the second fitting 44. The valve 48 is configured to permit fluid to flow from the pipe system 14 to the hose when the valve 48 is open and to prevent fluid from flowing from the pipe system 14 to the hose when the valve 48 is closed.

In some embodiments, the portion of the internal passage 46 between the outlet 18 and the pressure sensor 36 remains in fluid communication with the pipe system 14 regardless of operation of the valve 48. As a result, the leak detector 10 can detect a leak in the pipe system regardless of whether the hose is attached.

In some embodiments, detecting a leak in accordance with the present disclosure may be an automated process such as by way of one or more components of the leak detector 10, one or more auxiliary valve controllers to open and close the inlet 16 and outlets 18, and/or the premises monitoring system 22, or may be a manual process performed by the user on demand, e.g., through interaction with the leak detector 10 and/or premises monitoring system 22.

Further, various embodiments of the leak detector 10 and/or other components (e.g., valves, valve controllers, etc.) may be battery and/or solar powered.

The concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects. Any process, step, action and/or functionality described herein may be performed by, and/or associated to, a corresponding module, which may be implemented in software, firmware, and/or hardware. Furthermore, the embodiments of the present disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. Each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions and/or acts specified in the flowchart and/or block diagram block or blocks.

The functions and acts noted in the blocks may occur out of the order noted in the operational illustrations. For example, two blocks shown in succession may in fact be executed substantially concurrently or the blocks may sometimes be executed in the reverse order, depending upon the functionality and/or acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In addition, unless mention was made above to the contrary, the accompanying drawings are not to scale. A variety of modifications and variations are possible in light of the above teachings without departing from the scope and spirit of the present disclosure.

What is claimed is:

1. A leak detector for a pipe system, the pipe system having at least one inlet and a plurality of outlets, each of the at least one inlet and the plurality of outlets, the leak detector being configured to communicate in a premises monitoring system, the leak detector comprising:
a first fitting configured for connection to at least one outlet of the plurality of outlets;
a fluid pressure sensor configured to generate a plurality of fluid pressure measurements corresponding to fluid pressure in the pipe system;
at least one processor; and
at least one computer-readable medium storing a plurality of instructions that, when executed by the at least one processor, cause the at least one processor to:
generate fluid pressure data based on the plurality of fluid pressure measurements, the fluid pressure data comprising data representing at least a steady state pressure and a dynamic state pressure;
determine, based on at least the fluid pressure data, that a current fluid pressure of the pipe system satisfies at least one condition, the at least one condition comprising at least one of:
the current fluid pressure being lower than the steady state pressure, when the leak detector is in a first operative mode and the at least one inlet and the plurality of outlets are closed; or
the current fluid pressure being lower than the dynamic state pressure, when the leak detector is in a second operative mode and the at least one inlet and at least a first outlet of the plurality of outlets is open;
detect a leak based on the at least one condition being satisfied and based on a tolerance associated with the at least one condition, the tolerance being defined by a state of the premises monitoring system; and
cause an alert to be generated based on the leak being detected.

2. The leak detector of claim 1, further comprising:
a body connected to the first fitting and having an internal passage configured to be in communication with the pipe system;
a bleed valve operable to release gas from the internal passage;
a second fitting connected to the body and configured for connection to a hose;
a valve in fluid communication with the body and the second fitting;
a switch configured to cause the valve to open when the hose is connected to the second fitting and to cause the valve to close when the hose is not connected to the second fitting; and
the valve being configured to:
permit fluid to flow from the pipe system to the hose when the valve is open; and
prevent fluid from flowing from the pipe system to the hose when the valve is closed.

3. A leak detector, comprising:
a first fitting configured to couple to an outlet of a pipe system;
a fluid pressure sensor configured to generate a plurality of fluid pressure measurements corresponding to fluid pressure in the pipe system;
at least one processor; and
at least one computer-readable medium storing a plurality of instructions that, when executed by the at least one processor, cause the at least one processor to:
generate fluid pressure data based on the plurality of fluid pressure measurements, the fluid pressure data comprising data representing at least a steady state pressure and a dynamic state pressure;
determine, based on at least the fluid pressure data, that a current fluid pressure of the pipe system satisfies at least one leak condition;
detect a leak based on the at least one leak condition being satisfied; and
cause an alert to be generated based on the leak being detected.

4. The leak detector of claim 3, wherein the at least one leak condition comprises at least one of:
the current fluid pressure being lower than the steady state pressure, when the leak detector is in a first operative mode and at least one inlet and a plurality of outlets of the pipe system are closed; or
the current fluid pressure being lower than the dynamic state pressure, when the leak detector is in a second operative mode and the at least one inlet and at least a first outlet of the plurality of outlets of the pipe system are open.

5. The leak detector of claim 4, wherein the plurality of instructions is further configured to cause the at least one processor to cause the leak detector to enter the first operative mode based on a schedule.

6. The leak detector of claim 4, wherein the leak detector is in communication with a premises monitoring system, and the plurality of instructions is further configured to cause the at least one processor to cause the leak detector to enter the first operative mode based on a state of the premises monitoring system.

7. The leak detector of claim 3, wherein the leak detector is in communication with a premises monitoring system, and the plurality of instructions is further configured to cause the at least one processor to detect the leak based on a state of the premises monitoring system.

8. The leak detector of claim 7, wherein the plurality of instructions is further configured to cause the at least one processor to:
determine a tolerance associated with the at least one leak condition and defined by the state of the premises monitoring system; and
detect the leak based on the tolerance.

9. The leak detector of claim 8, wherein:
the state of the premises monitoring system is one of a plurality of potential states of the premises monitoring system; and
the plurality of instructions is further configured to cause the processor to determine the tolerance by at least selecting, based on the state of the premises monitoring system, the tolerance from a plurality of potential tolerances, each tolerance of the plurality of potential tolerances corresponding to one of the plurality of potential states of the premises monitoring system.

10. The leak detector of claim 3, further comprising:
a body connected to the first fitting and comprising an internal passage in fluid communication with the pipe system; and
a bleed valve operable to release gas from the internal passage.

11. The leak detector of claim 3, further comprising:
a body;
a second fitting connected to the body and configured for connection to a hose;
a valve in fluid communication with the body and second fitting;
a switch configured to cause the valve to open when the hose is connected to the second fitting and to cause the valve to close when the hose is not connected to the second fitting; and
the valve being configured to:
permit fluid to flow from the pipe system to the hose when the valve is open; and
prevent fluid from flowing from the pipe system to the hose when the valve is closed.

12. A method implemented in a leak detector, the method comprising:
generating fluid pressure data based on a plurality of fluid pressure measurements, the fluid pressure data comprising data representing at least a steady state pressure and a dynamic state pressure;
determining, based on at least the fluid pressure data, that a current fluid pressure of a pipe system satisfies at least one leak condition;
detect a leak based on the at least one leak condition being satisfied; and
causing an alert to be generated based on the leak being detected.

13. The method of claim 12, wherein the at least one leak condition comprises at least one of:
the current fluid pressure being lower than the steady state pressure, when the leak detector is in a first operative mode and at least one inlet and a plurality of outlets of the pipe system are closed; or
the current fluid pressure being lower than the dynamic state pressure, when the leak detector is in a second operative mode and the at least one inlet and at least a first outlet of the plurality of outlets of the pipe system are open.

14. The method of claim 13, further comprising entering the first operative mode based on a schedule.

15. The method of claim 13, the leak detector is in communication with a premises monitoring system, and the method further comprises entering the first operative mode based on a state of the premises monitoring system.

16. The method of claim 12, wherein the leak detector is in communication with a premises monitoring system, and the method further comprises detecting the leak based on a state of the premises monitoring system.

17. The method of claim 16, wherein the method further comprises:
determining a tolerance associated with the at least one leak condition and defined by the state of the premises monitoring system; and
detecting the leak based on the tolerance.

18. The method of claim 17, wherein:
the state of the premises monitoring system is one of a plurality of potential states of the premises monitoring system; and
determining the tolerance by at least selecting, based on the state of the premises monitoring system, the tolerance from a plurality of potential tolerances, each tolerance of the plurality of potential tolerances corresponding to one of the plurality of potential states of the premises monitoring system.

19. The method of claim 12, wherein:
the leak detector comprises:
a first fitting configured to couple to an outlet of the pipe system;
a body connected to the first fitting and comprising an internal passage in communication with the pipe system; and
a bleed valve in fluid communication with the internal passage; and
the method further comprises opening the bleed valve to release gas from the internal passage.

20. The method of claim 12, wherein:
the leak detector further comprises:
a body;
a second fitting connected to the body and configured for connection to a hose;
a valve in fluid communication with the body and the second fitting; and
a switch in communication with the valve;
the method further comprising:
causing the valve to open to permit fluid to flow from the pipe system to the hose when the hose is connected to the second fitting; and
causing the valve to close to prevent fluid from flowing from the pipe system to the hose when the hose is not connected to the second fitting.
